(19) United States
(12) Patent Application Publication
(10) Pub. No.: US 2020/0004705 A1
(43) Pub. Date: Jan. 2, 2020

(54) METHOD OF RETRIEVING DATA OF EQUIPMENT

(71) Applicant: ADLINK TECHNOLOGY INC., New Taipei (TW)

(72) Inventors: Ming-Chun HSIEH, New Taipei (TW); Yi-Lin LIAO, New Taipei (TW); Chun-Hsiang YANG, New Taipei (TW)

(21) Appl. No.: 16/025,220

(22) Filed: Jul. 2, 2018

(51) Int. Cl. G06F 13/20; G06F 13/42; G05B 19/4063

(52) U.S. Cl. CPC G06F 13/20; G05B 2219/31098; G05B 19/4063; G06F 13/42

(57) ABSTRACT

A method of retrieving data of equipment is disclosed. In the method, a host is interconnected to a control host of at least one machine equipment through network, and host uses AutoItX dll to enter an application program of control host, and then uses AutoIt Window information tool to retrieve a control ID of the control item of the to-be-retrieved date item, and select a function parameter defined in the AutoItX dll. The retrieved control ID and control item title are inputted into the selected function parameter program associated with the control item, to retrieve at least one piece of application data of the at least one machine equipment, the control host of the at least one machine equipment transmits the retrieved application data to the host through network, so that the host can obtain instant state data of the to-be-retrieved date item, to achieve the objective of real-time monitoring.

### BACKGROUND OF THE INVENTION

### 1. Field of the Invention

The present invention relates to a method of retrieving data of equipment, more particularly to a method of monitoring the data of machines on a production line in real time; in the method, a host is connected to a control host of at least one machine equipment through network, to retrieve the parameter of a control item of to-be-retrieved data, so that the host can acquires the instant data of the machine equipment.

### 2. Description of the Related Art

As the times changed from traditional agriculture age to the industrial age, and then into the era of science and technology, many industrial products and technology products are developed to bring people a lot of comfort and convenience in daily life and work. In order to respond to the needs of the industrial and technological development, various types of processing machines, industrial plants, and high-tech plants have been established, and using automated manufacturing processes are applied to quickly and accurately manufacture various types of industrial and technological products for meeting the needs of modern people. Furthermore, in order to increase production capacity, the industrial plants or high-tech plants are continuously expanded to have plant area and add processing tools or machine tools, thereby enlarging and speeding up the production process to produce a large number of products and increase the economic benefits. For the industrial or high-tech plant with a large area and equipped with various types and large amounts of processing and production machines, automation processing machines are useful to save processing costs and improve the performance of the production line; for example, the automation processing machines may include NC (numerical control) tool machine, CNC (computer numerical control) tool machine, or MC (machining center) integrated cutting center tool machine, and each of these automated processing machines is equipped with a host that can be controlled by programs. Most of the programmable control hosts use microprocessor control systems or computer program control systems to receive processing instructions written using letters, numbers, and symbols, to further control various processes and operations of the processing machines. By using automated production and processing operations, the industrial or high-tech plants can increase production capacity and product yield, and effectively reduce manufacturing costs.

After most processing and production operations are performed by automated processing machines, the manpower required to operate the machines and the cost of personnel operations can be reduced. Generally, the processing machines have different operational conditions and operational information, such as instant states about performance data, speed, flow, production capacity, temperature or humidity. However, each of various types of processing machines has the separate programmable control host and perforins manufacturing and processing process separately, so it is hard to obtain and understand the instant states of all processing machines accurately and in real time. A staff can be assigned to inspect the processing machines, but the staff only can visually inspect the operations of the processing machines, or check whether the data displayed on the control hosts of the processing machines is normal, and it is hard for the staff to find abnormal state of the processing machine during actual operation. As a result, the abnormal state cannot be found until a problem occurs in the processing machine to trigger an alarm, and upon receipt of the alarm, the staff goes to the site for maintenance and repair. During the maintenance, the staff must pause and interrupt the operation of the processing machine, and it causes the reduction of working capacity, or delay of production line operations. Furthermore, the abnormal state or the alarm of the processing machine cannot be controlled and prevented in advance. It will become a problem for the modern industrial or high-tech plant.

Therefore, how to solve the problems that it is not easy to monitor and control the instant states of the processing machines of industrial or high-tech plants during operation, and it is hard to understand and prevent the potential abnormal states of the processing machines in advance, is a key issue for the manufacturers in this industry.

### SUMMARY OF THE INVENTION

In order to solve aforementioned conventional problems, the inventor collects associated data and performs multiple tests and modifications according to the collected data and years of experience, to develop the method of retrieving data of equipment, and in the method, a host can use Autolt Window information tool to retrieve data of a control host of at least one machine equipment, for understanding the instant state of the machine equipment, so as to obtain instant data from the control host of the at least one machine equipment.

An objective of the present invention is that, in this method, the host is interconnected to the control host of the at least one machine equipment through network, and, the host uses AutoItX dll to enter the application program of the control host, and use Autolt Window information tool to retrieve a control ID of the control item of the to-be-retrieved date item, and select a function parameter defined in the AutoItX dll, and input the retrieved control ID and control item title into the selected function parameter program associated with the control item; next, to retrieve application data of the at least one machine equipment, for example, the data about instant state of the machine equipment, such as performance, speed, flow, production capacity, temperature or humidity during operation. Next, the control host of the at least one machine equipment transmits the retrieved application data to the host through network, so that the host can obtain the instant state data of the to-be-retrieved data item, to achieve the objective of real-time monitoring.

Another objective of the present invention is that the host can be a desktop computer, a notebook computer or a tablet computer, host can be installed with Windows XP, Windows 2003, Windows Vista, Windows 7. Windows 2008 R2, Windows 8, Windows 2012 R12, or Windows 10, or operating system of associated software program, and also installed with operation program including Autolt Window information tool and AutoItX dll, so that the host can retrieve the instant state data of the at least one processing machine equipment during operation, and the retrieved instant state data can be temperature, humidity, processing speed, motor speed, conveyor speed, chain speed or process flow sequence.

Another objective of the present invention is that the at least one machine equipment can be an automatic processing machine, an automatic transport machine or an automated production line which each includes an electronic control host (NC, CNC, MC or DNC). The control host of the at least one machine equipment can be installed with software program of based on or Microsoft NET Framework. The function parameter of the control item of the control host is relevant parameter including a serial number, a password, a number string, text string or code of the control item of the application program of control host.

### BRIEF DESCRIPTION OF THE DRAWINGS

FIG. 1 is a block diagram of an embodiment of the present invention.

FIG. 2 is a first flow chart of a method of retrieving data, according to an embodiment of the present invention.

FIG. 3 is a second flow chart of the method of retrieving data, according to an embodiment of the present invention.

FIG. 4 is a front view of machine equipment of an embodiment of the present invention.

FIG. 5 is a flow chart of a method of a preferred embodiment of the present invention.

FIG. 6 is a flow chart of a method of another embodiment of the present invention.

FIG. 7 is a schematic view of a page displayed on a host screen of another embodiment of the present invention.

FIG. 8 is a flow chart of a method of alternative embodiment of the present invention.

FIG. 9 is a schematic view of a page displayed on a host screen of alternative embodiment of the present invention.

### DETAILED DESCRIPTION OF THE PREFERRED EMBODIMENTS

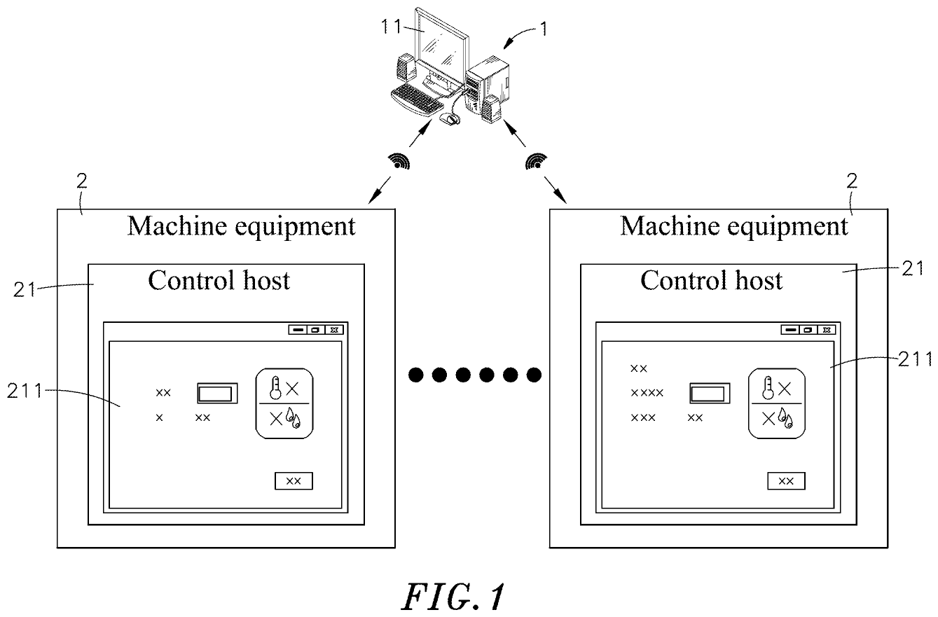

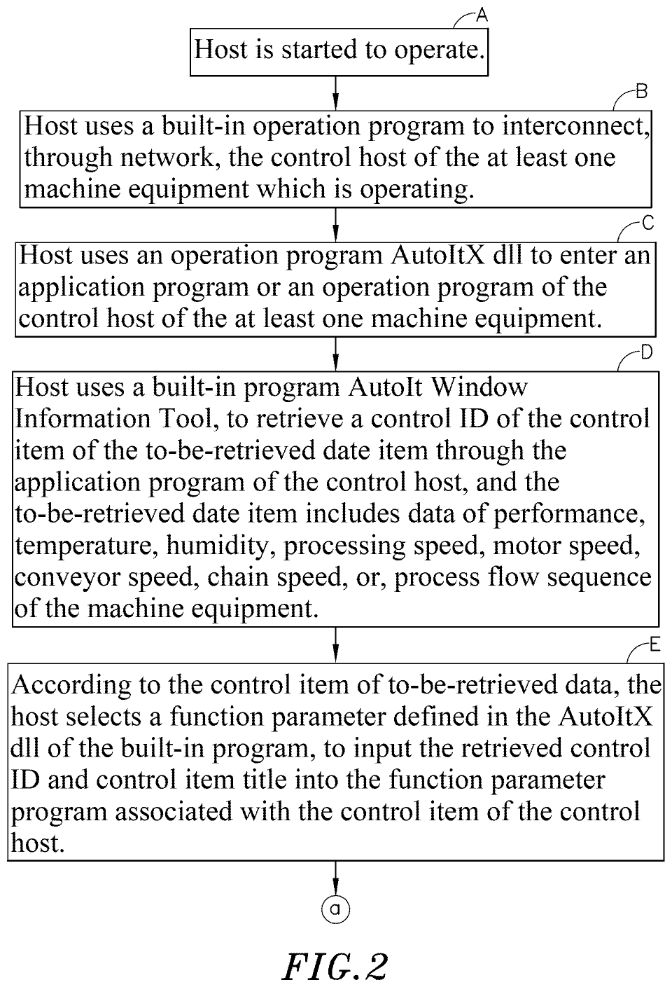

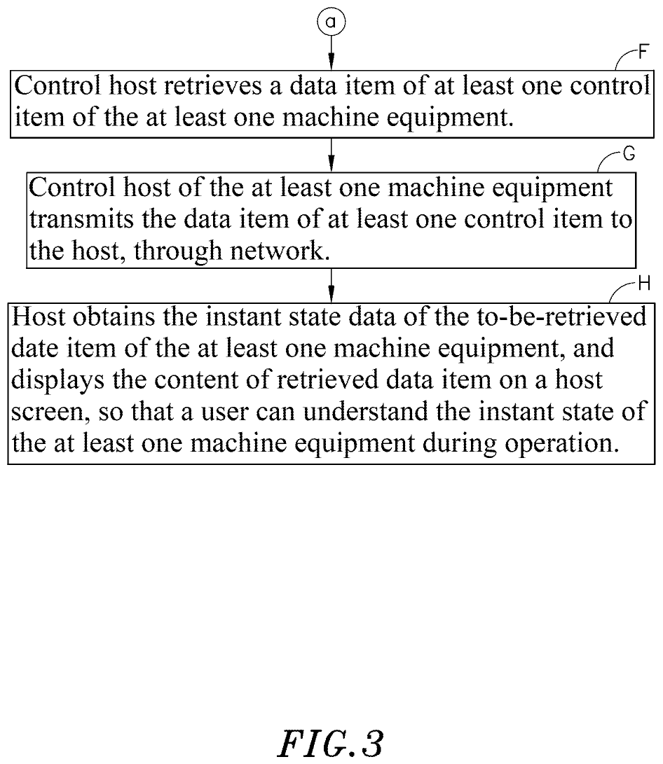

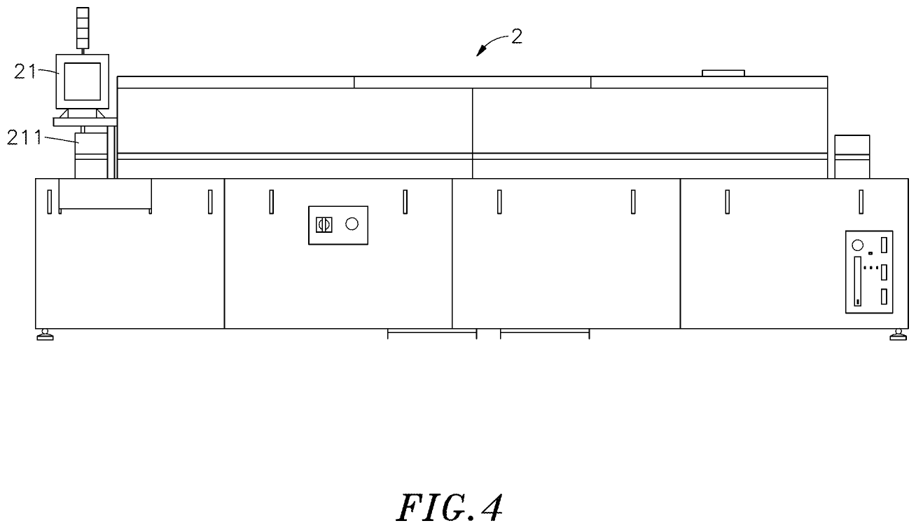

Please refer to FIGS. 1 to 4, which are block diagram of an embodiment of the present invention, first and second flow charts of an embodiment of the present invention, and front view of machine equipment of an embodiment of the present invention, the method can be applied to a host 1 and at least one machine equipment 2, and the method of retrieving data includes steps (A) to (H).

In the step (A), the host 1 is started to operate.

In the step (B), the host 1 uses a built-in operation program to interconnect, through network, a control host 21 of the at least one machine equipment 2 which is operating.

In the step (C), the host 1 uses an operation program AutoItX dll to enter an application program or an operation program of the control host 21 of the at least one machine equipment 2.

In the step (D), the host 1 uses a built-in program Autoh Window Information Tool, to retrieve a control ID of the control item of the to-be-retrieved date item through the application program of the control host 21, and the to-be-retrieved date item includes data of performance, temperature, humidity, processing speed, motor speed, conveyor speed, chain speed, or, process flow sequence of the machine equipment 2.

In the step (E), according to the control item of to-be-retrieved data, the host 1 selects a function defined in the AutoItX dll of the built-in program, to input the retrieved control ID and control item title into the function parameter associated with the control item of the control host 21.

In the step (F), the control host 21 retrieves a data item of at least one control item of the at least one machine equipment 2.

In the step (G), the control host 21 of the at least one machine equipment 2 transmits the data item of at least one control item to the host 1, through network.

In the step (H), the host 1 obtains the instant state data of the to-be-retrieved date item of the at least one machine equipment 2, and displays the content of retrieved data item on a host screen 11, so that a user can understand the instant state of the at least one machine equipment 2 during operation.

The host 1 can be a desktop computer, a notebook computer or a tablet computer, and the host 1 can be installed with the application software including application program or operating system. Preferably, the host 1 can be installed with Windows XP, Windows 2003, Windows Vista, Windows 7, Windows 2008 R2, Windows 8, Windows 2012 R12, or Windows 10, or operating system of associated software program, and also installed with operation program including Autolt Window information tool and AutoItX dll. The host 1 can retrieve instant state data of the at least one machine equipment 2 during operation, for example, the instant state data of the to-be-retrieved date item can be the data about performance, temperature, humidity, processing speed, motor speed, conveyor speed, chain speed or process flow sequence of the at least one processing machine equipment 2 during operation. The associated information of the instant state data of the at least one machine equipment 2 is displayed on the host screen 11.

The at least one machine equipment 2 can be an automatic processing machine, an automatic transport machine or an automated production line which each is provided with an electronic control host (NC, CNC, MC or DNC). The control host 21 of the at least one machine equipment 2 can be installed with based on or Microsoft NET Framework. The function parameter of the control item of the control host 21 is parameter including a serial number, a password, a number string, text string or code of the control item of the application program of the control host 21. The control host 21 can include a display screen 211 to display information of the operation program or the retrieved data item.

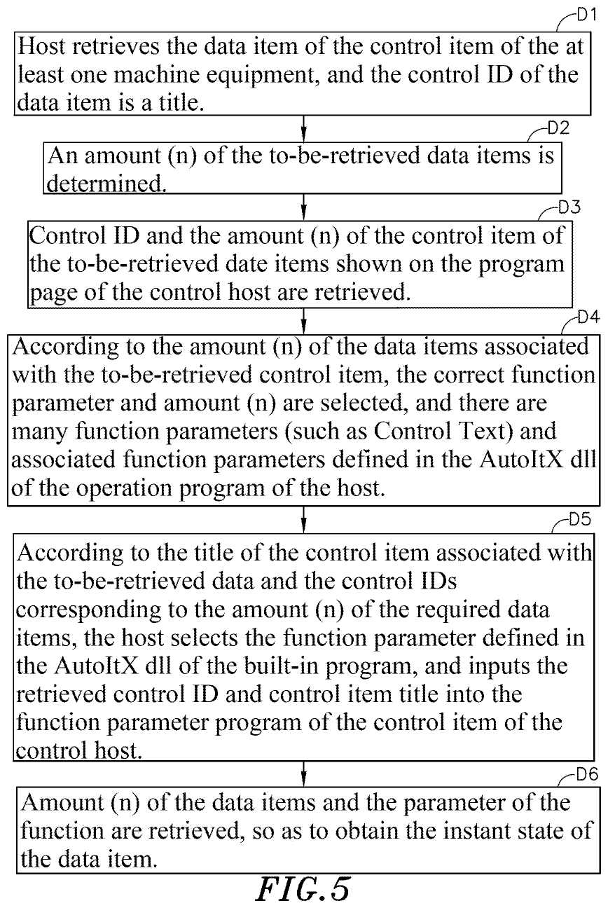

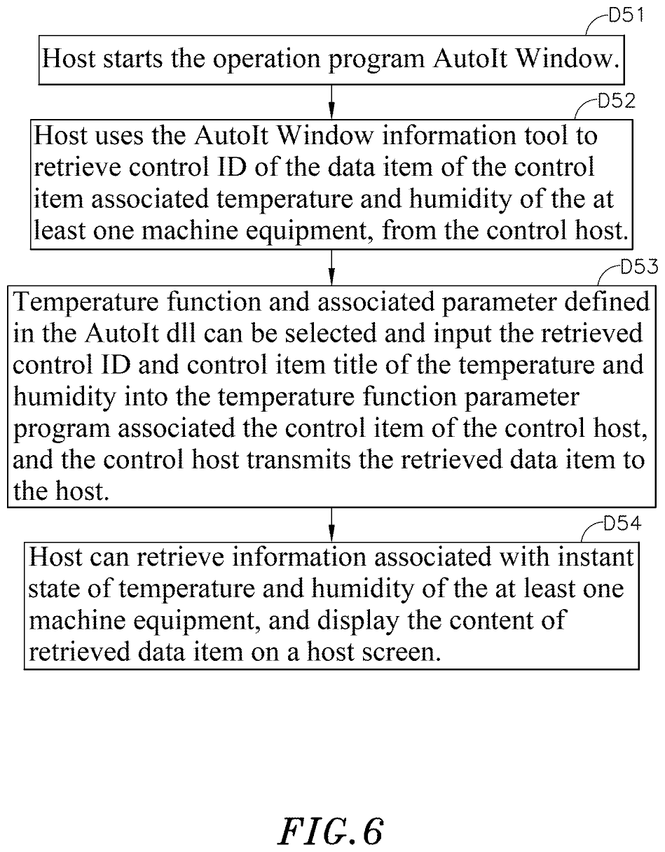

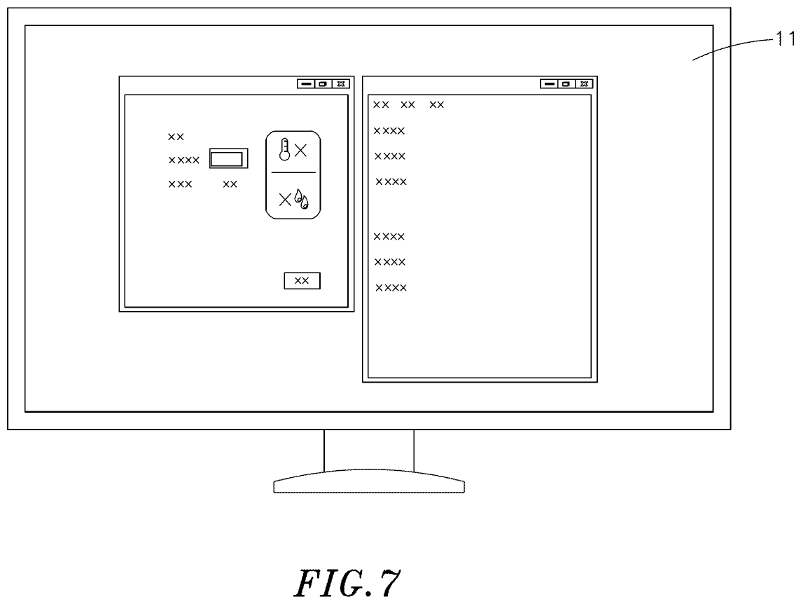

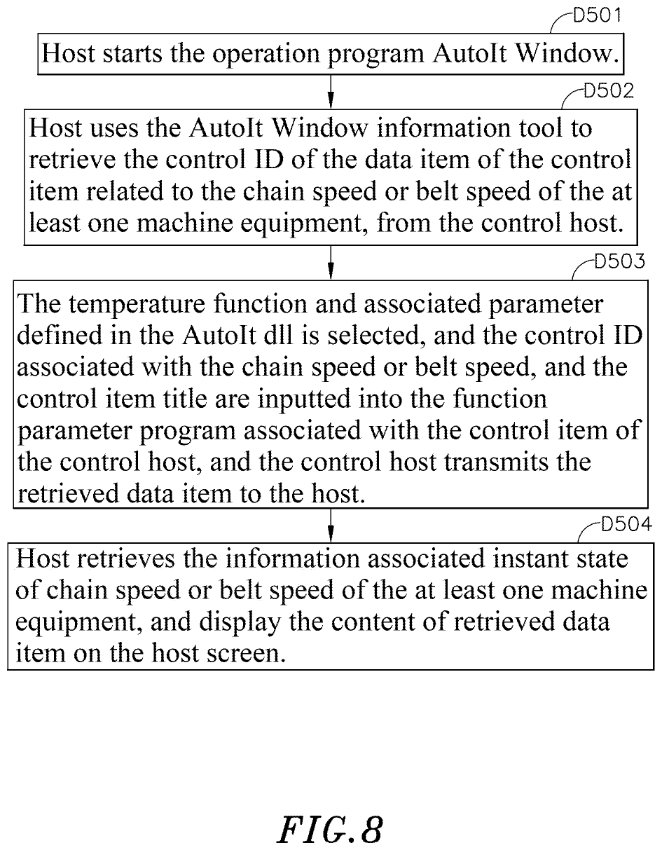

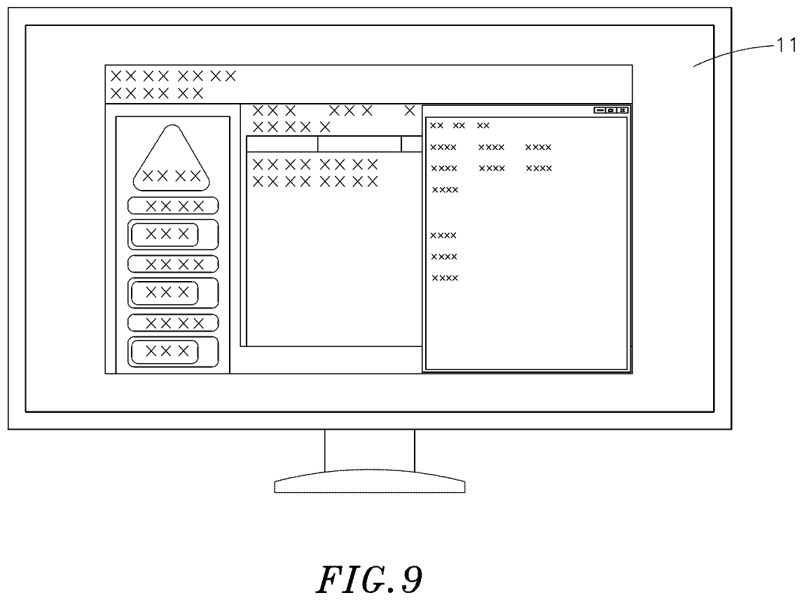

Please refer to FIGS. 1 to 9, which show block diagram of an embodiment of the present invention, first and second flow charts of the method of an embodiment of the present invention, a front view of machine equipment of an embodiment of the present invention, a flow chart of a preferred embodiment of the present invention, flow chart of another embodiment, schematic view of page displayed on a host screen of another embodiment, a flow chart of alternative embodiment, schematic view of page displayed on a host screen of alternative embodiment. In the step (D) of method of retrieving data, the host 1 uses the built-in program Autolt Window information tool; and, after the application program of the control host 21 retrieves the control ID of the control item of the to-be-retrieved date item, and the to-be-retrieved date item includes data of performance, temperature, humidity, processing speed, motor speed, conveyor speed, chain speed, or, process flow sequence of the machine equipment 2, the step of retrieving application data of the control item of the control host 21 can include steps (D1) to (D6).

In the step (D1), the host 1 retrieves the data item of the control item of the at least one machine equipment 2, and the control ID of the data item is a title.

In the step (D2), an amount (n) of the to-be-retrieved data items is determined.

In the step (D3), the control ID and the amount (n) of the control item of the to-be-retrieved date items shown on the program page of the control host 21 are retrieved.

In the step (D4), according to the amount of the data items associated with the to-be-retrieved control item, the correct function parameter and amount (n) are selected. There are many function parameters (such as Control Get Text) and associated function parameters defined in the AutoItX dll of the operation program of the host 1.

In the step (D5), according to the title of the control item associated with the to-be-retrieved data and the control IDs corresponding to the amount of the required data items, the host 1 selects the function parameter defined in the AutoItX dll of the built-in program, and inputs the retrieved control ID and control item title into the function parameter program of the control item of the control host 21.

In the step (D6), the amount (n) of the data items and the parameter of the function are retrieved, so as to obtain the instant state of the data item.

According to the step (D5), in a condition of the data item of the to-be-retrieved control item is temperature and humidity data of the at least one machine equipment 2, the following steps (D51) to (D54) can be performed.

In the step (D51), the host 1 starts the operation program Autolt Window.

In the step (D52), the host 1 uses the Autolt Window information tool to retrieve control ID of the data item of the control item associated temperature and humidity of the at least one machine equipment 2, from the control host 21.

In the step (D53), the temperature function and associated parameter defined in the Autolt dll can be selected and input the retrieved control ID and control item title of the temperature and humidity into the function parameter program of the control item of the control host 21, and the control host 21 transmits the retrieved data item to the host 1.

In the step (D54), the host 1 can retrieve information associated with instant state of temperature and humidity of the at least one machine equipment 2, and display the content of retrieved data item on a host screen 11.

According to the step (D5), in a condition that the data item of the to-be-retrieved control item is data of the instant state of chain speed or belt speed of the at least one machine equipment 2, the following steps (D501) to (D504) can be performed.

In the step (D501), the host 1 starts the operation program AutoIt Window.

In the step (D502), the host 1 uses the AutoIt Window information tool to retrieve the control ID of the data item of the control item related to the chain speed or belt speed of the at least one machine equipment 2, from the control host 21.

In the step (D503), the temperature function and associated parameter defined in the AutoIt dll is selected, and the control ID associated with the chain speed or belt speed, and the control item title are inputted into the function parameter program of the control item of the control host 21, and the control host 21 transmits the retrieved data item to the host 1.

In the step (D504), the host 1 can retrieve the information associated instant state of chain speed or belt speed of the at least one machine equipment 2, and display the content of retrieved data item on the host screen 11.

The host 1 retrieves the data item of the control item of the at least one machine equipment 2, for example, the data item about the performance, the temperature, the humidity, the processing speed, the motor speed, the conveyor speed, the chain speed or process flow sequence of the machine equipment 2. According to the title of the control item associated with the to-be-retrieved data and the control ID corresponding to the amount (n) of the required data item, the host 1 selects the function parameter defined in the AutoItX dll of the built-in program, and inputs the retrieved control ID and control item title into the function parameter associated with the control item of the control host 21, for monitoring the at least one machine equipment 2 disposed in the industrial plant, high-tech plant or the processing production line, in real time. Therefore, the user can obtain the information of the instant state of the machine performance, temperature, humidity, processing speed, motor speed, conveyor speed, chain speed or process flow sequence of the at least one machine equipment 2 during processing operation, and understand the processing operation condition of the at least one machine equipment 2. Furthermore, the abnormal condition of the at least one machine equipment 2 can be predicted before occurrence, so that the operations of precautionary management, detection, maintenance or repair can be performed before occurrence of the abnormal condition, to ensure the processing operation flow to be performed smoothly without being interrupted or stopped, thereby achieving the improvement in quality, yield rate and production of product, and effective reduction in manufacturing cost.

The foregoing description is merely for exemplary illustration, and not intended to limit the scope of claim of the present invention. In the method, the host 1 is interconnected to the control host 21 of the at least one machine equipment 2 through network, and the host 1 then uses the AutoItX dll to enter application program of the control host 21, and uses the Autolt Window Information Tool to retrieve the control ID of the control item associated with to-be-retrieved data; and, after the function parameter defined in the AutoItX dll of the host 1 is selected, the control ID is inputted into the selected parameter program of the control item of the control host 21, and the control host 21 can retrieve the data item of the at least one machine equipment 2, and transmit the retrieved data item to the host 1 through network, thereby achieving the objective of enabling the host to retrieve the instant state data of the at least one machine equipment 2. As a result, the host 1 can effectively know the instant operation state of the at least one machine equipment 2, so that the operation of precautionary detection, maintenance or repair can be performed before occurrence of abnormal condition, to ensure the processing operation to be performed smoothly, thereby improving quality and production of products. The example disclosed herein has been described by means of specific embodiments. However, numerous modifications, variations and enhancements can be made thereto by those skilled in the art without departing from the spirit and scope of the disclosure set forth in the claims.

The main concept of the present invention is to provide the method of retrieving data of equipment, and the host can use the built-in application program to enter the application program of the control host of at least one machine equipment, and then use the AutoIt Window Information Tool to retrieve the control ID of to-be-retrieved item from the control host, and select the parameter defined in the AutoItX dll, and input the control ID and the parameter into the selected function associated the control item of the control host, so as to retrieve the desired data item; and, the control host can transmit the retrieves data item to the host through network, so that the host can retrieve the information of the instant state of the at least one machine equipment, and understand the processing operation state of the at least one machine equipment. As a result, the host can timely perform operation of manage, detection, maintenance or repair, according to the operation state of the at least one machine equipment, thereby improving quality and production of products.

The present disclosure disclosed herein has been described by means of specific embodiments. However, numerous modifications, variations and enhancements can be made thereto by those skilled in the art without departing from the spirit and scope of the disclosure set forth in the claims.

What is claimed is:

1. A method of retrieving data of equipment, applicable to a host and at least one machine equipment, and the method comprising:
(A) starting the host to operate;
(B) interconnecting the host to a control host of the at least one machine equipment through network;
(C) using AutoItX dll, at the host, to enter an application program of the control host of the at least one machine equipment;
(D) using AutoIt Window Information Tool, at the host, to obtain a control ID of a control item associated with to-be-retrieved date item from the application program of the control host;
(E) selecting, by the host according to the control item associated with the to-be-retrieved date item, a function parameter defined in the AutoItX dll, and inputting the retrieved control ID and a control item title into the function parameter of the control item of the control host;
(F) retrieving at least one data item of the at least one machine equipment;
(G) transmitting, by the control host of the at least one machine equipment, the retrieved the at least one data item to the host; and
(H) obtaining, at the host, instant state data of the retrieved date item of the at least one machine equipment.

2. The method according to claim 1, wherein, in the step (A), the host is a desktop computer, a notebook computer, or a tablet computer.

3. The method according to claim 2, wherein the operating system built in the host is Microsoft software program system comprising Windows XP, Windows 2003, Windows Vista, Windows 7, Windows 2008 R2, Windows 8, Windows 2012 R12, or Windows 10.

4. The method according to claim 2, wherein the host is installed with an operating system, and the Autolt Window Information Tool and the AutoItX dll are built in the operating system.

5. The method according to claim 1, wherein, in the step (A), the at least one machine equipment comprises a processing machine, automatic transport machine or automated production line, and each of the processing machine, the automatic transport machine and the automated production line comprises an electronic control host (NC, CNC, MC or DNC).

6. The method according to claim 5, wherein the at least one machine equipment is installed with software program of based on or Microsoft NET Framework.

7. The method according to claim 1, wherein, in the steps (D) and (H), the instant state data of the retrieved date item comprises data of temperature, humidity, processing speed, motor speed, conveyor speed, chain speed or process flow sequence of the at least one machine equipment during operation.

8. The method according to claim 1, wherein, in the step (E), the function parameter of the control item is a serial number, password, number string, text string or code of the control item of the application program of the control host.
